(19) United States
(12) Patent Application Publication
(10) Pub. No.: US 2016/0033101 A1
(43) Pub. Date: Feb. 4, 2016

(54) DUAL BEAM PATTERN VEHICULAR LIGHTING ASSEMBLY

(71) Applicant: Ford Global Technologies, LLC, Dearborn, MI (US)

(72) Inventors: Li Yan, Troy, MI (US); Ketan K. Desai, Farmington Hills, MI (US); David A. Brown, West Bloomfield, MI (US); Stephen Kenneth Helwig, Farmington Hills, MI (US); Sleiman N. Abdelnour, Macomb, MI (US)

(73) Assignee: Ford Global Technologies, LLC

(21) Appl. No.: 14/448,583

(22) Filed: Jul. 31, 2014

(51) Int. Cl. F21S 8/10

(52) U.S. Cl. CPC F21S 48/1283; F21S 48/1154

(57) ABSTRACT

A vehicle lighting assembly that comprises: a single lens having a first and a second plurality of near-field lens elements, and an exit surface; and a first and a second LED source that directs light through the respective first and second plurality of lens elements. The first and the second plurality of lens elements are configured to transmit light in a respective spread pattern and a high-intensity pattern through the exit surface. The assemblies can be configured such that the spread pattern and the high-intensity pattern collectively meet the low beam headlight requirements set forth in any current global vehicular lighting regulation, e.g., the current U.S. NHTSA Motor Vehicle Safety Standard No. 108.

### FIELD OF THE INVENTION

The present invention generally relates to lighting modules and assemblies and, more particularly, to vehicular headlamp assemblies.

### BACKGROUND OF THE INVENTION

Conventional vehicle headlamps employ numerous components (e.g., a light source, collector, and light distributor). Even more advanced vehicle headlamps employing light emitting diode (“LED”) light sources often have numerous components, typically pairing each LED source with a lens. Automotive designs generally place certain size and dimensional limitations on vehicle headlamps. Further, the sizing of headlamps can in part be dictated by beam spread requirements dictated by federal regulations, depending on the particular application for the headlamp (e.g., low beam, high beam, etc.). Headlamps with numerous components with larger packaging footprints, even if employing more energy-efficient light sources, can present disadvantages in terms of their contributions to vehicle weight.

Accordingly, there is a need for vehicular lighting modules and assemblies that offer shape and packaging flexibility, particularly for use in headlamp applications requiring particular beam spread patterns.

### SUMMARY OF THE INVENTION

According to one aspect of the present invention, a vehicle lighting assembly is provided that comprises: a single lens having a first and second plurality of near-field lens elements, and an exit surface; and a first and second LED source that directs light through the respective first and second plurality of lens elements. The first and the second plurality of lens elements are configured to transmit light in a respective spread pattern and a high-intensity pattern through the exit surface.

According to another aspect of the present invention, a vehicle lighting assembly is provided that comprises: a single lens having a first and second plurality of near-field lens elements and exit elements; and a first and second LED source that directs light through the respective first and second plurality of lens elements. The first and the second plurality of lens elements are configured to transmit light in a respective spread pattern and a high-intensity pattern through the respective first and second plurality of exit elements.

According to a further aspect of the present invention, a vehicle lighting assembly is provided that comprises: a single lens having a plurality of lens modules, and an exit surface; and a plurality of LED sources that direct light through the plurality of lens modules. The plurality of lens modules is configured to transmit light in a respective spread pattern and high-intensity pattern through the exit surface and each lens module comprises two or more near-field lens elements.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front, perspective view of a vehicle headlamp assembly that includes a pair of vehicle lens modules with substantially rectangular exit surfaces according to an aspect of this disclosure;

FIG. 1A is a rear, perspective view of the vehicle headlamp assembly depicted in FIG. 1;

FIG. 1B is a cross-sectional view of the vehicle headlamp assembly depicted in FIG. 1 at line IB-IB;

FIG. 1C is a cross-sectional view of the vehicle headlamp assembly depicted in FIG. 1 at line IC-IC;

FIG. 1D is an enlarged view of the LEDs and input surfaces in the vehicle headlamp assembly depicted in FIG. 1;

FIG. 2 is a perspective view of an arrangement of vehicle headlamp assemblies employed in low and high beam headlamp assemblies according to an aspect of the disclosure; and

FIG. 3 is a plot of luminous intensity for a low beam headlamp assembly as depicted in FIG. 2 according to a further aspect of the disclosure.

### DETAILED DESCRIPTION OF THE PREFERRED EMBODIMENTS

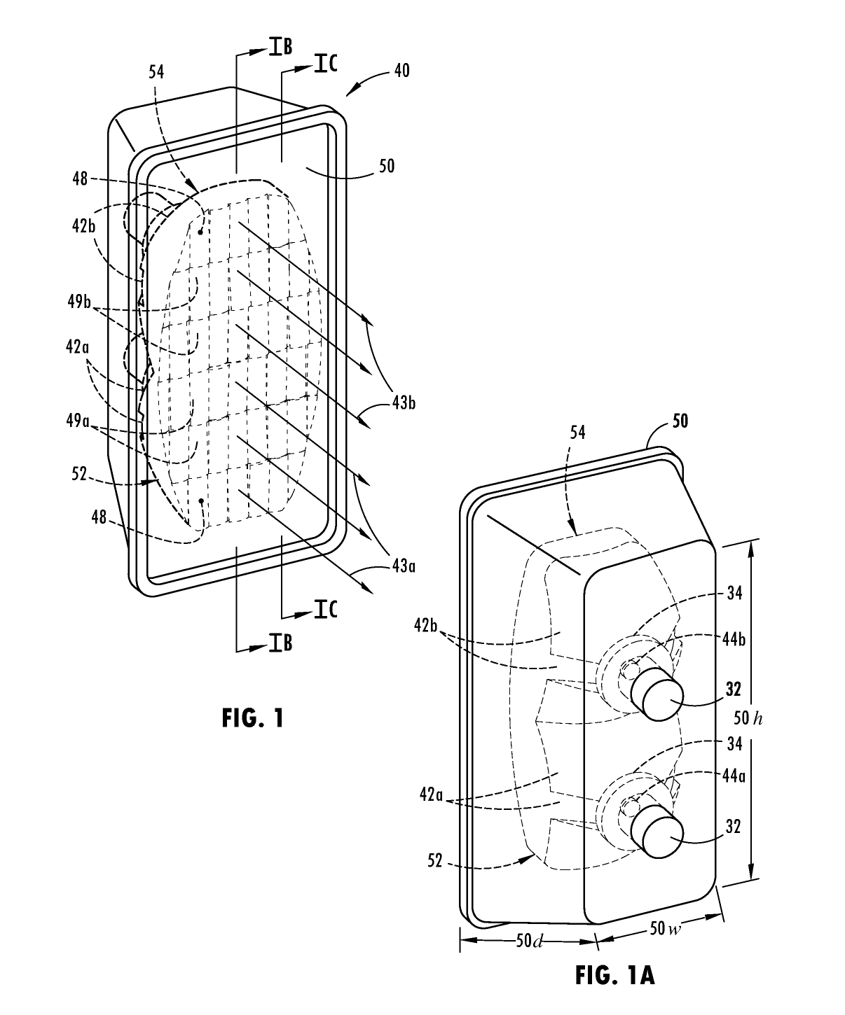

For purposes of description herein, the terms “upper,” “lower,” “right,” “left,” “rear,” “front,” “vertical,” “horizontal,” and derivatives thereof shall relate to the invention as oriented in FIG. 1. However, the invention may assume various alternative orientations, except where expressly specified to the contrary. Also, the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIGS. 1-1C, a vehicle headlamp assembly 40 is depicted according to an aspect of the disclosure with a pair of adjacent lens modules 52, 54 configured within a headlamp case 50. Modules 52, 54 can be configured to produce spread (e.g., relatively large, low intensity region) and spot (e.g., a small, high intensity region) light patterns 43a and 43b, respectively. In some embodiments, the light patterns 43a and 43b can collectively satisfy the low beam headlight requirements set forth in any current global vehicular lighting regulation, e.g., the current U.S. National Highway Traffic Safety Administration (“NHTSA”) Motor Vehicle Safety Standard No. 108 (“FMVSS 108”). Together, the modules 52, 54 embody a lens 41 having an exit surface 48. The headlamp assembly 40 further includes LED light sources 44a and 44b such that each source directs incident light through the respective lens modules 52, 54 and lens 41. In some embodiments, LED light sources 44a and 44b are mounted to printed circuit boards (PCBs) 34 and heat sinks 32 (see FIGS. 1A and 1B).

As also depicted in FIGS. 1-1C, the lens 41 includes a first and second plurality of near-field lens (“NFL”) elements 42a and 42b that correspond to the respective lens modules 52 and 54. These near-field lens elements 42a and 42b are configured to transmit from the exit surface 48 of the lens 41 respective spread and spot light patterns 43a and 43b containing at least a substantial portion of the incident light from LED light sources 44a and 44b. Further, the exit surface 48 of lens 41 is depicted as substantially rectangular in shape, whereas input surfaces 46a and 46b (see FIG. 1B) of the lighting modules 52 and 54 are substantially circular in shape. In addition, the exit surface 48 of the lens 41 includes a first and second plurality of exit surface elements 49a and 49b. The exit surface elements 49a and 49b correspond to the lens modules 52 and 54 and LED light sources 44a and 44b, respectively.

According to an embodiment, the LED light sources 44a and 44b of the vehicle headlamp assembly 40 produce light that is generally directed into the input surfaces 46a and 46b of the lens modules 52, 54, respectively (see FIG. 1B). The input surfaces 46a and 46b are each configured according to dimensional and mathematical relationships to collimate the light from the sources 44a and 44b into spot and spread patterns 43a and 43b. For example, input surfaces 46a and 46b may be generally parabolic in nature to collimate and reflect incident light from the sources 44a and 44b outward from the assembly as patterns 43a and 43b as shown in FIGS. 1, 1B and 1C.

Referring again to FIGS. 1-1C, the incident light that travels through the input surfaces 46a and 46b leaves the lens 41 via the exit surface 48. In some aspects, the exit surface 48 can be configured with a first and second plurality of exit surface elements 49a and 49b to further refine or otherwise shape the light patterns produced by the input surfaces 46a and 46b into spread and spot patterns 43a and 43b. As such, each of the exit surface elements 49a and 49b can include a collection of optical elements that can be configured to further optimize the uniformity of the spread and spot patterns 43a and 43b. For example, the tip angle (e.g., about a lateral vehicular axis in a vehicle forward or rearward direction) and outer curvature (e.g., convex, concave, bowed, etc.) of each element 49a, 49b can be individually adjusted to optimize the uniformity and directionality of the spread and spot patterns 43a and 43b (see, e.g., FIG. 1). In a preferred arrangement of the vehicle headlamp assembly 40, a substantial quantity of the total number of elements 49a and 49b are dissimilar in terms of their tip angle and/or outer curvature (see FIGS. 1, 1B and 1C).

The lens 41 and, particularly the exit surface 48, can take on a variety of shapes, including the substantially rectangular shape depicted in FIGS. 1-1C. In some embodiments, the exit surface 48 is arranged in a substantially circular or elliptical configuration. Packaging requirements and particular spread and intensity levels required by the final application can also influence the final shape factor chosen for the lens 41 and the exit surface 48. As for the input surfaces 46a and 46b, they are generally arranged in a substantially circular configuration to efficiently collect the majority of incident light from the LED light sources 44a and 44b. The input surfaces 46a and 46b can also be configured in substantially rectangular configurations to accommodate LED light sources 44a and 44b that produce incident light in a substantially linear pattern.

As shown in FIG. 1D, the LED distances 47a, 47b between the LED light sources 44a, 44b and input surfaces 46a, 46b can be controlled to affect the uniformity, spread and location of the spread and spot patterns 43a and 43b. In some preferred implementations, an LED distance 47a of about 5 mm and an LED distance 47b of about 6 mm are employed in the vehicular headlamp assembly 40 to produce suitable spread and spot patterns 43a and 43b. It should also be understood that LED distances 47a and 47b can be optimized and adjusted to produce various beam spread patterns that are the sum of spread and spot patterns 43a and 43b for various headlamp or other lighting requirements and/or governmental regulations.

Referring again to FIGS. 1-1C, the lens 41 can be fabricated from an optically translucent material, such as polycarbonate, glass or other comparable materials. Generally, the materials used to fabricate the lens 41 have a high optical quality and are capable of being manufactured to tight tolerances. The exit surface 48, NFL elements 42a and 42b, and input surfaces 46a and 46b are integrated within the lens 41. Accordingly, lens 41 is typically fabricated from one piece of material.

The LED light sources 44a and 44b can be selected from various LED lighting technologies, including those that can emanate light of wavelengths other than in the visible spectrum or various colors. Further, various color filters and other optical elements (e.g., diffusers) can be employed immediately in front of or part of the light sources 44a and 44b to produce certain desired optical effects associated with the spread and spot patterns 43a and 43b. It should be understood that the LED light sources 44a and 44b are located in proximity to the input surfaces 46a and 46b to facilitate the efficient collection of incident light by the surfaces 46a and 46b of the lens 41.

As further shown in FIGS. 1-1C, the plurality of NFL elements 42a and 42b of the vehicle headlamp assembly 40 can be configured to transmit collimated light patterns, e.g., spread and spot patterns 43a and 43b, containing a substantial percentage of incident light from LED light sources 44a and 44b. In some aspects, at least 60% of the incident light from the sources 44a and 44b is transmitted through the exit surface 48. In other aspects, it is preferable to configure the NFL elements 42a and 42b such that at least 70% of the incident light (or at least 80% of the incident light in some configurations) is transmitted through the exit surface 48. There are relatively few aspects of the vehicle headlamp assembly 40 that can lead to a loss of light intensity. The incident light from LED light sources 44a and 44b is directed immediately into input surfaces 46a and 46b. Thereafter, the light is redirected and collimated by the plurality of NFL elements 42a and 42b within lens 41. There are no other surfaces that reflect incident light—a process that usually results in 10-20% loss in light intensity. Hence, the overall light transmission efficiency of the vehicle headlamp assembly 40 can exceed 60%.

As shown in FIG. 1B, the internal lens distances 51a, 51b between the input surfaces 46a, 46b and the exit surface elements 49a, 49b can also be controlled to affect the uniformity, spread and location of the spread and spot patterns 43a and 43b. In a preferred implementation, an internal lens distance 51a, 51b of less than about 28 mm can be employed in the vehicular headlamp assembly 40 to produce efficient spread and spot patterns 43a and 43b. It should also be understood that internal lens distances 51a and 51b can be optimized and adjusted to produce various beam spread patterns that are the sum of spread and spot patterns 43a and 43b for various headlamp or other lighting requirements and/or governmental regulations.

As noted earlier, the NFL elements 42a and 42b in FIGS. 1-1C of the vehicle headlamp assembly 40 are configured to collimate the incident light from LED light sources 44a and 44b. The incident light from the sources 44a and 44b is usually Lambertian in character with significant scattering in various directions. In other words, light emanates and spreads from the source in all directions—on the order of 180 degrees. It should also be understood that each NFL element 42a, 42b can consist of a plurality of NFL lenses. In some embodiments, each lens may possess a focal length that is the same or differs from the focal lengths of the other lenses in the NFL elements 42a, 42b. In some aspects of the headlamp assembly 40, each NFL element 42a, 42b consists of two NFL lenses, each lens having a different focal length. As such, the lenses of each of the NFL elements 42a and 42b can work together to collimate the incident light from the sources 44a and 44b.

As also depicted in FIGS. 1-1C, the vehicle headlamp assembly 40 can include the case 50 having depth 50d, width 50w and height 50h dimensions. The depth 50d can be defined by the distance from the LED sources 44a and 44b to the exit surface 48. In one exemplary implementation, the case 50 has a depth 50d of approximately 28 mm, a height 50h of approximately 60 mm and a width 50w of approximately 32 mm. The packaging footprint, including depth 50d, of the case 50 can be minimized based on the particular construction of the lens 41. The lens 41 consists of at least two lens modules 52 and 54. These lens modules 52 and 54 are not merely single elements joined together to form lens 41. Rather, the input surfaces 46a and 46b, the exit surface 48, and the exit surface elements 49a and 49b are designed such that the lens modules 52 and 54 are merged together to form lens 41. In some embodiments of vehicle headlamp assembly 40, the case 50 and lens 41 are configured such that the depth 50d is set at 50 mm or less. In other aspects of the headlamp assembly 40, the depth 50d is set at 30 mm or less.

In some embodiments, the vehicle headlamp assembly 40 can include a case 50, a lens 41 having a plurality of lens modules (e.g., lens modules 52, 54, and more) and an exit surface 48. Each lens module is paired with an LED lighting source (e.g., LED light sources 44a, 44b, and so on) that directs incident light through the respective lens module and out of the exit surface 48. Further, the lens modules are configured to produce a spread pattern 43a and spot pattern 43b. One subset of the plurality of the lens modules can be devoted to producing the spread pattern 43a and the remainder of the lens modules can be configured to produce the spot pattern 43b. In some aspects, the exit surface 48 is itself divided into discrete exit surface elements (e.g., exit surface elements 49a, 49b, and so on) that correspond to particular lens modules. These exit surface elements can also be configured and optimized to produce the respective spot and spread patterns 43a and 43b for the vehicle headlamp assembly 40. In other embodiments, the vehicle headlamp assembly 40 can include one or more lens modules 52 or 54 configured to solely produce spread or spot patterns 43a and 43b. Put another way, some embodiments of headlamp assembly 40 are configured to produce only spread pattern 43a or spot pattern 43b, as necessary for certain lighting applications.

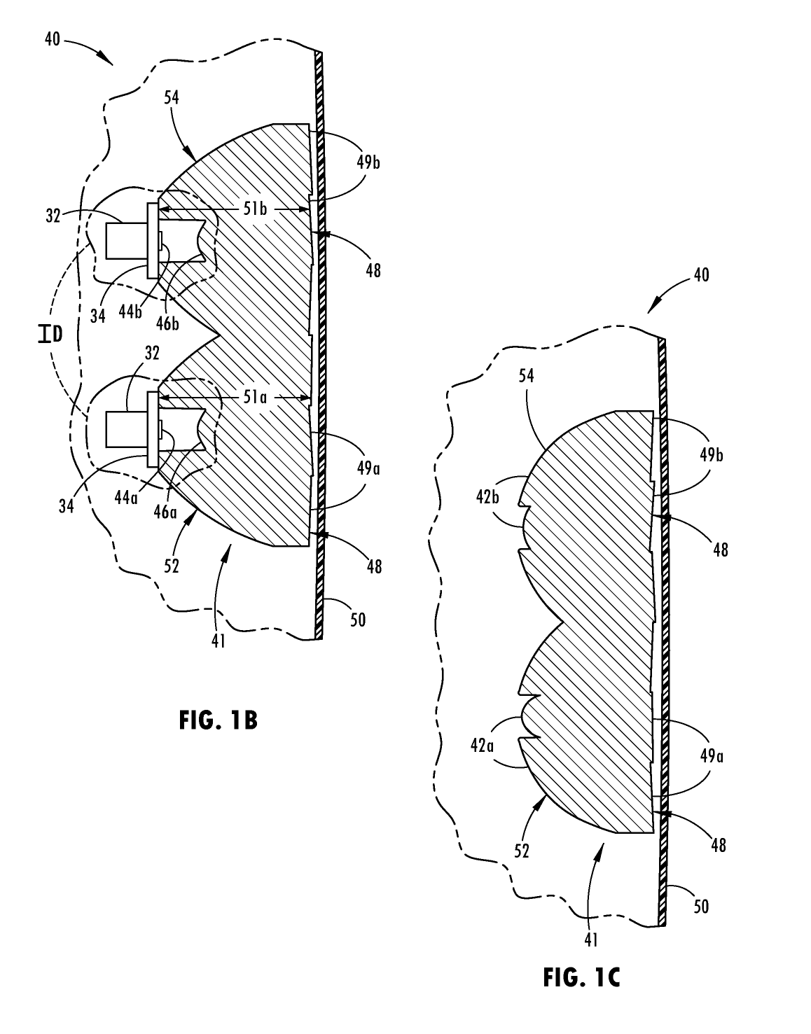

Referring now to FIG. 2, a low beam headlamp assembly 100 can consist of a set of three headlamp assemblies 40. Further, a high beam headlamp assembly 200 can also consist of two headlamp assemblies 20. With regard to the low beam headlamp assembly 100, the outermost headlamp assemblies 40 can be configured to produce only spread patterns 43a. For example, two sets of lens modules 52 can be employed for the outermost headlamp assemblies 40. As for the centermost headlamp assembly 40 within the low beam headlamp assembly 100, it can be configured to produce spread and spot patterns 43a and 43b, respectively. The spread and spot patterns 43a and 43b collectively produced by the headlamp assemblies 40 of the low beam headlamp assembly 100 can satisfy the FMVSS 108, for example,

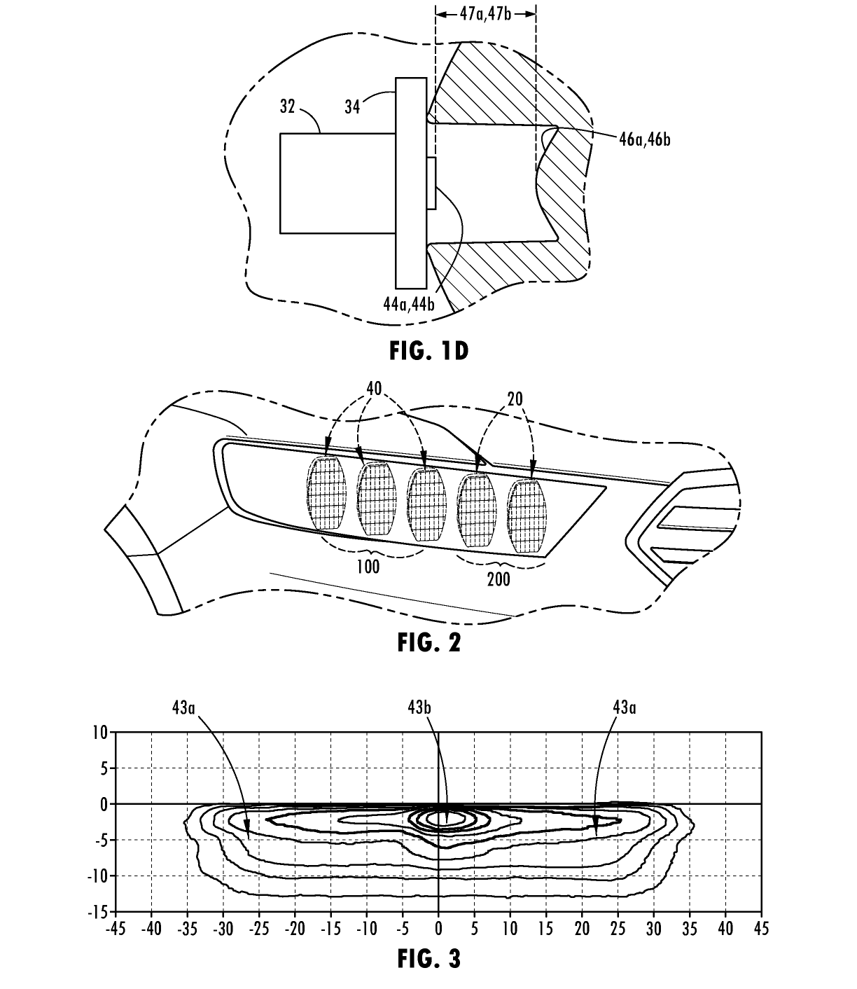

As shown in FIG. 3, a low beam vehicle headlamp assembly 100 with three headlamp assemblies 40 according to an embodiment (see, e.g., FIG. 2) can be used to generate a light pattern that satisfies the low beam FMVSS 108 requirements. The hot spot pattern 43b is shown in the relative center of the pattern with high intensity levels (e.g., luminous intensity levels of 15000 candelas (cd) or more). In some aspects, the spot pattern 43b can be produced solely by the topmost lens module 54 of the centermost headlamp assembly 40 within the low beam assembly 100. The spread pattern 43a is also depicted in FIG. 3, and surrounds the spot pattern 43b. The spread pattern 43a, as shown in FIG. 3, has intensity levels that range from 125 candelas (cd) to 15000 candelas (cd). In some aspects, the spread pattern 43a can be produced by the outermost vehicle headlamp assemblies 40 and a portion of the centermost vehicle headlamp assembly 40 of the low beam assembly 100. As such, a collection of vehicle headlamp assemblies 40, each with one lens 41, case 50 and two LED lighting sources 44a and/or 44b, can produce a collective lighting pattern suitable for use in a low beam vehicular headlight configuration.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle lighting assembly, comprising:
a single lens having a first and second plurality of near-field lens elements, and an exit surface; and
a first and second LED source that directs light through the respective first and second plurality of lens elements,
wherein the first and second plurality of lens elements are configured to transmit light in a respective spread pattern and a high-intensity pattern through the exit surface.

2. The lighting assembly according to claim 1, wherein the first and second plurality of near-field lens elements each consist of at least two near-field lenses.

3. The lighting assembly according to claim 1, wherein the spread pattern and the high-intensity pattern collectively meet the low beam headlight requirements set forth in the current U.S. Federal Motor Vehicle Safety Standard 108.

4. The lighting assembly according to claim 1, wherein the exit surface of the lens is arranged in a substantially rectangular shape.

5. The lighting assembly according to claim 1, wherein the exit surface of the lens comprises a plurality of optical elements configured to further shape the spread and high-intensity patterns into a low-beam vehicular headlight pattern.

6. The lighting assembly according to claim 5, wherein the plurality of optical elements further comprises a substantial portion of optical elements that are dissimilar in terms of at least one of their tip angle and outer curvature.

7. The lighting assembly according to claim 1, wherein the LED sources and the exit surface of the lens collectively define a maximum assembly depth of about 50 mm or less.

8. The lighting assembly according to claim 1, wherein the LED sources and the exit surface of the lens collectively define a maximum assembly depth of about 30 mm or less.

9. A vehicle lighting assembly, comprising:
a single lens having a first and second plurality of near-field lens elements and exit elements; and
a first and second LED source that directs light through the respective first and second plurality of lens elements,
wherein the first and second plurality of lens elements are configured to transmit light in a respective spread pattern and a high-intensity pattern through the respective first and second plurality of exit elements.

10. The lighting assembly according to claim 9, wherein the first and the second plurality of near-field lens elements each comprise at least two near-field lenses.

11. The lighting assembly according to claim 9, wherein the spread pattern and the high-intensity pattern collectively meet the low beam headlight requirements set forth in the current U.S. Federal Motor Vehicle Safety Standard 108.

12. The lighting assembly according to claim 9, wherein the first and second plurality of exit elements are collectively arranged in a substantially rectangular shape.

13. The lighting assembly according to claim 9, wherein the first and second plurality of exit elements are collectively configured to further shape the spread and high-intensity patterns into a low-beam vehicular headlight pattern.

14. The lighting assembly according to claim 13, wherein the first and second plurality of exit elements further comprises a substantial portion of optical elements that are dissimilar in terms of at least one of their tip angle and outer curvature.

15. The lighting assembly according to claim 9, wherein the LED sources and the first and second plurality of exit elements collectively define a maximum assembly depth of about 50 mm or less.

16. The lighting assembly according to claim 9, wherein the LED sources and the first and second plurality of exit elements collectively define a maximum assembly depth of about 30 mm or less.

17. A vehicle lighting assembly, comprising:
a single lens having a plurality of lens modules, and an exit surface; and
a plurality of LED sources that direct light through the plurality of lens modules,
wherein the plurality of lens modules is configured to transmit light in a respective spread pattern and high-intensity pattern through the exit surface and each lens module comprises two or more near-field lens elements.

18. The lighting assembly according to claim 17, wherein the spread pattern and the high-intensity pattern collectively meet the low beam headlight requirements set forth in the current U.S. Federal Motor Vehicle Safety Standard 108.

19. The lighting assembly according to claim 17, wherein the plurality of LED sources and the exit surface of the lens collectively define a maximum assembly depth of about 50 mm or less.

20. The lighting assembly according to claim 17, wherein the plurality of LED sources and the exit surface of the lens collectively define a maximum assembly depth of about 30 mm or less.
